(19) United States
(12) Patent Application Publication
(10) Pub. No.: US 2025/0263926 A1
(43) Pub. Date: Aug. 21, 2025

(54) SOILING SOLUTION

(71) Applicant: USG Interiors, LLC, Chicago, IL (US)

(72) Inventors: Connor Jacob Wigand, Libertyville, IL (US); Peder John Gulbrandsen, Aurora, IL (US); Timothy Joe Miller, Mundelein, IL (US); Samuel David Hulka, Mount Prospect, IL (US)

(21) Appl. No.: 18/444,832

(22) Filed: Feb. 19, 2024

(51) Int. Cl. E04C 2/52; B32B 3/26; B32B 5/02; B32B 7/14; B32B 19/04; B32B 19/06; B32B 27/36; B32B 37/12; B32B 37/20; E04C 2/04

(52) U.S. Cl. CPC E04C 2/526; B32B 3/266; B32B 5/022; B32B 7/14; B32B 19/045; B32B 19/06; B32B 27/36; B32B 37/1292; B32B 37/203; E04C 2/043; B32B 2255/02; B32B 2255/26; B32B 2305/18; B32B 2307/10; B32B 2315/14; B32B 2367/00; B32B 2607/00

(57) ABSTRACT

In combination, a drywall panel perforated front to back across the full area of the panel, relatively thin film across a backside of the panel with uniform low tension, adhesive in discrete lines between the backside of the panel and isolating perforations from other perforations, the adhesive maintaining the film off of the drywall adjacent the perforations, areas of the film exceeding respective areas of the panel covered thereby such that the film is loose from the drywall at the perforations and capable of vibrating when subjected to sound in the perforations, the film preventing air flow through the perforations.

### BACKGROUND OF THE INVENTION

The invention relates to improvements in acoustical boards.

### PRIOR ART

Drywall or gypsum boards have been modified with a plurality of through holes to construct a monolithic ceiling or wall with acoustic properties. A problem exists where room air passes through the holes and airborne dirt particles accumulate around the hole entrance. This phenomena exists especially when the drywall sheets are used for a ceiling and the plenum above the ceiling is used to conduct return air.

### SUMMARY OF THE INVENTION

It has been discovered that a high level of acoustic absorption can be maintained if the holes in the drywall are closed with a film adhesively but loosely attached to the reverse side of the drywall. The film prevents air flow through the holes and consequent soiling while allowing noise to pass through.

### BRIEF DESCRIPTION OF THE DRAWINGS

FIG. 1 is a schematic view of a laminating process;

FIG. 2 is a showing of a preferred relationship of glue lines and perforations on a drywall board;

FIG. 3 illustrates four constructions of different acoustic performance utilizing the perforate gypsum board and soil preventing film of the invention; and

FIG. 4 is a diagrammatic representation of a cross-section of a drywall perforation, glue lines, and soil preventing film.

### DESCRIPTION OF THE PREFERRED EMBODIMENT

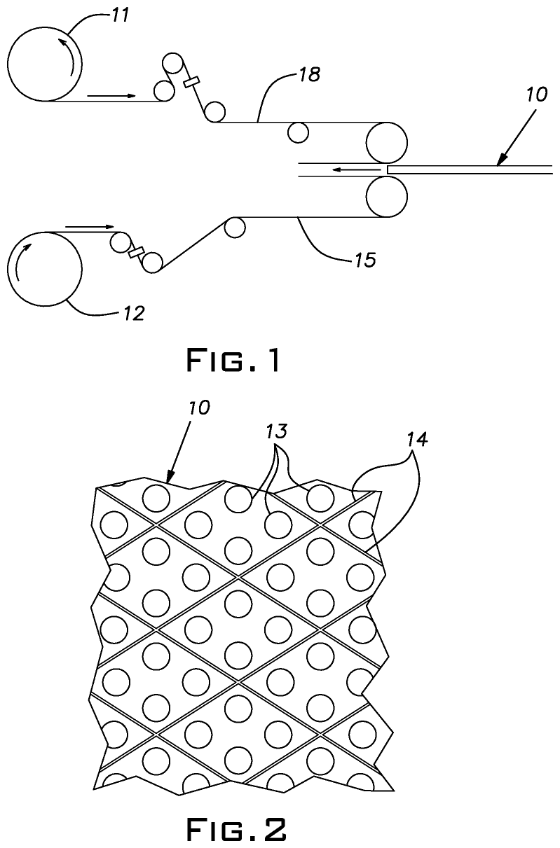

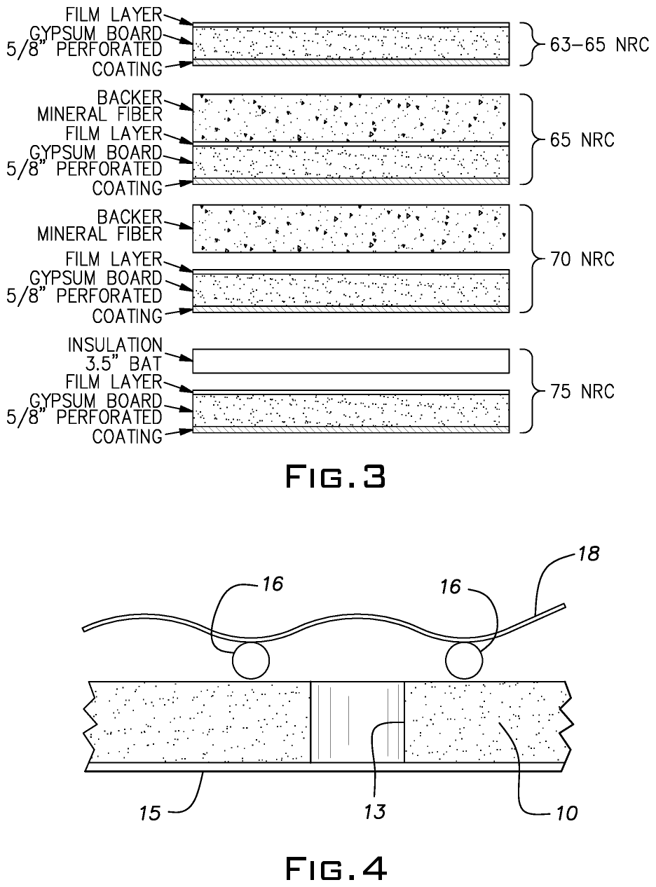

A perforated drywall or gypsum board 10, typically ⅝ inch thick, is laminated with scrim 15 on a roll 12 and with an anti-soiling film 18 on a roll 11 (FIG. 1). The board 10 is through-perforated from front to back with holes 13. FIG. 2 shows a typical area of the board 10 with holes 13 of ⅜ inch diameter and a preferable pattern of glue lines 1 following paths between the holes 13. It will be understood that the entire front and rear face areas of the board 10 are perforated and the rear face is covered with glue lines 14. A non-woven, acoustically transparent scrim or veil, designated 15, for example is that marketed by Owens Corning Veil Netherlands B.V. and is adhesively fixed to the board 10 as is known to those in the industry. When covered with an acoustically transparent coating, the veil 15 and coating serve to optically obscure the perforations 13 from their side. In FIG. 3, the veil 15 and coating are collectively labeled “coating” and the anti-soiling film 18 is labeled “film layer”.

The anti-soiling film 18, for example, is relatively thin, imperforate, plastic film, for example 0.0005 inch thick polyethylene terephthalate (PET). Adhesive 16 forming the lines 14 is a polyvinyl acetate (PVA) rubber-based adhesive. The film 18 is drawn from the roll 11, and is adhered to the panel 10 by adhesive 16.

The film 18 is applied to the panel 10 from the roll 11 with very low tension so that the surface area of the film is greater than the surface area of the board covered, the differential being at least 10% and no more than 20%. A board or panel area of 3 inch squared would be 3.3 square inches of film.

Referring to FIG. 4, the glue or adhesive 16 has sufficient body to hold the film 18 0.025-0.045 inch off the panel 10 and is relatively soft, measuring less than 50 on the Shore 00 scale.

The described film 18 and application process produces a perforated board and film composite that is non-soiling and affords several levels of acoustical performance.

FIG. 3 demonstrates four different noise reduction coefficient (NRC) levels that can be obtained with the panel/film combination. The panel film composite alone can yield 63-65 NRC. When in contact with a mineral fiber backer the composite achieves a 65 NRC. If the composite is spaced from a mineral fiber backer a 70 NRC can be obtained and when spaced from an insulation bat, the composite can produce an NRC of 75. A spacing of 1 to 2 inches works well and a spacing of 1.25 to 1.5 inches appears to be optimum regardless of the nature of the sound absorber and has proven to give the highest NRC ratings. One and one-half inches of space is achieved when the acoustic backer lies on top of a grid tee of 1-½ inch height.

It has been found that if the glue lines become out of phase with the perforations there is no adverse effect on the acoustic performance of the board. It is important that the glue lines prevent air flow from the occupied space to the plenum above the panel through the perforations 13.

The film 18 can contain a black or opaque filler to prevent light from shining through the holes 13 from the plenum.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. In combination, a drywall panel perforated front to back across the full area of the panel, relatively thin film across a backside of the panel with uniform low tension, adhesive in discrete lines between the backside of the panel and isolating perforations from other perforations, the adhesive maintaining the film off of the drywall adjacent the perforations, areas of the film exceeding respective areas of the panel covered thereby such that the film is loose from the drywall at the perforations and capable of vibrating when subjected to sound in the perforations, the film preventing air flow through the perforations.

2. The combination of claim 1, wherein a front side of the drywall panel is covered with a nonwoven acoustically transparent scrim and the scrim is coated with an acoustically transparent coating, the scrim and coating serving to optically obscure the perforations while allowing passage of sound into the perforations.

3. The combination of claim 1, and an acoustical backer spaced 1 to 2 inches from a back side of the panel.

4. A method of making an acoustical panel comprising supplying a drywall sheet perforated front to back across the expanse of the sheet applying a thin sheet of plastic film with uniform low tension from a supply roll to a backside of the drywall sheet, forming discrete lines of adhesive that isolate perforations from other perforations and that adhere the film to the drywall sheet back side, the adhesive and film preventing air flow through the perforations and thereby preventing soiling of the areas surrounding the perforations.

5. A method as set forth in claim 4, wherein an acoustical absorber is spaced from the backside of the drywall sheet.

6. A method as set forth in claim 5, wherein the acoustical backer is spaced between 1 and 2 inches from the backside of the drywall sheet.

7. A method as set forth in claim 4, wherein a front side of the drywall is coated with a sound transparent scrim and a sound transparent coating, the scrim and coating serving to obscure the perforations.
